(19) United States
(12) Patent Application Publication
(10) Pub. No.: US 2002/0186867 A1
(43) Pub. Date: Dec. 12, 2002

(54) Filtering of recommendations employing personal characteristics of users

(75) Inventors: Srinivas Gutta, Buchanan, NY (US); Kaushal Kurapati, Yorktown Heights, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/878,607

(22) Filed: Jun. 11, 2001

(51) Int. Cl. G06K 9/00

(52) U.S. Cl. 382/116

(57) ABSTRACT

A system and method for filtering selections and presenting recommendations. A filter that is associated with a media system receives data comprising one or more personal characteristics of a user of the media system. The filter determines at least one recommendation for the user of a selection available on the media system based upon at least one of the personal characteristics of the user.

### FIELD OF THE INVENTION

The invention relates to processing and filtering for presenting recommendations to a user of a media system or device.

### BACKGROUND OF THE INVENTION

Particular filtering techniques, and the systems and devices that support them, are known. In general, filtering is applied to selections available to a user via a media system or device and presents a narrower selection to a user. The narrower selection is typically presented as one or more recommendations to the user. For example, television programs available for viewing, after filtering, may present a smaller list of selections to the user. As another example, filtering of the entire catalog of CDs available for purchase on a website may present a smaller list tailored to the likely preferences of the user.

A filter typically comprises or otherwise has access to a database that organizes selections according to one or more criterion. For example, one simple criterion is categorization of available selections. Thus, television programs may be categorized by the filter according to science fiction, sit-com, comedy, drama, etc. Input from the user is processed by the filter and is used in conjunction with the organizational scheme of the database to identify a narrower selection of recommendations for the user.

For example, when the user selects a particular show to watch, the filter may process the selection and identify it as being in the sit-com category. The filter may then access the database for other programs that have been categorized as sit-coms, which are output to the user as recommendations. As another example, after selecting a female jazz artist on a CD website, the filter may determine that the corresponding category is “female jazz” (or two categories comprising “jazz” and “female”). The filter may then utilize the categories from the input to search the database for all releases by female jazz artists within 6 months and output them as recommendations for the user.

In another example, collaborative filtering techniques generally rely on what other users have done. The filter uses the history of what others have done as a criteria in organizing the database.

For example, in the case of television programs, what other programs viewers of program A are watching may be compiled. (Of course, the filter may only track a sample of viewers of program A and may only do so over a finite period of time.) Thus, a list of “other programs” may be associated with program A. The list of other programs may be weighted based on how many viewers are determined to be watching each of the other program. Alternatively, for example, an other program may only make the list that is associated with program A if a threshold number of viewers of program A subsequently tune into the other program. The data may be created and loaded into a database associated with the filter, or it may be downloaded or accessed from an external source. When a user tunes into program A, the filter accesses the database for other programs associated with program A and presents them as recommendations to the user.

Other television programs will have a list of associated programs created in a like manner; thus viewers of any program (B, C, etc.) will have a list of other programs recommended to them based on the viewing habits of other viewers of program B, C, etc. In the example of the CD website, subsequent CD purchases by buyers of a particular CD may be compiled and stored in the filter database. When a user purchases the particular CD, the other CDs purchased by the previous buyers of the particular CD may be recommended to the user. In an even more basic example of collaborative filtering, a product may be recommended to a user based on what the majority of other users have purchased, accessed, etc., without any correlation to the particular input of the user.

Thus, collaborative filtering techniques usually employ what other users have done in a holistic manner. That is, recommendations are created based solely on the past behavior of a mass of users, without distinguishing further amongst such users. A holistic approach to collaborative filtering is thus a relatively crude empirical approach, since it is simply based on tracking behavior of all users (or a sampling of all users) in general. In addition, such holistic collaborative filtering techniques make recommendations to a user based (at most) on the objective input provided by the user and not on any other individual characteristics.

In short, the known collaborative filtering techniques create a black box of behavior based on a non-distinguished mass of users and presume that the individual user it is making a recommendation to has preferences that conform to the black box of the mass. The known techniques fail to provide recommendations that consider or utilize information regarding individual users, which may provide a more refined recommendation than simply copying mass behavioral patterns.

### SUMMARY OF THE INVENTION

It is thus an objective of the invention to provide filtering that takes into account user characteristics apart from what the user has chosen and what prior users who selected the same item then subsequently selected. It is an objective of the invention to take into account personal characteristics of the user in filtering and presenting recommendations. It is also an objective to compile filtering recommendations automatically, without any input from the users that provide the basis for the filter. It is also an objective to provide filtering recommendations that take into account personal characteristics automatically, without any input from the user regarding his or her personal characteristics.

In accordance with these objectives, the invention provides a filter that provides recommendations for a user of a media system or device that takes into account one or more personal characteristics that are particular to the user. The filter comprises a processor and has access to a database of selections available on the media system or device. Some or all of the available selections have one or more associated personal characteristics. The filter receives or identifies one or more user associated personal characteristics and processing software searches the database for selections having at least one selection associated personal characteristic that matches the one or more user associated personal characteristics. If there is a match, the selection may be output as a recommendation to the user.

The database may be organized in a number of different ways. For example, each of the available selections may have one or more personal characteristic associated therewith. In that case, the processor searches the selections of the database and considers whether the one or more personal characteristics associated with each selection matches any of the one or more user personal characteristics. Alternatively, the database may be organized according to personal characteristics, with each of the available selections associated with one or more personal characteristics. In that case, the processor finds the one or more personal characteristic in the database that corresponds to the one or more user personal characteristics, and considers the selections associated with those one or more personal characteristics in the database.

If there are more than one user personal characteristic, then it may be required that a selection have two or more associated personal characteristics that match the user personal characteristics before a recommendation of the selection is made. Alternatively, if some personal characteristics are of higher importance than others, there may be a weighted scoring of matches between user personal characteristics and selection personal characteristics for a selection. If the scoring exceeds a threshold, the selection is output as a recommendation.

Personal characteristics may include gender, age, ethnic background, etc. For example, if a personal characteristic used by the filter is gender, then the user personal characteristic (that is, the personal characteristic of a particular user) may be “male”. Each selection in the media system may then have “male” and/or “female” associated with it as a selection associated personal characteristic.

The user personal characteristics may be automatically detected using an image capturing device and image recognition software associated with the media system or device, as well as the filter. The image capturing device may capture an image of a scene that includes the user, which is then transmitted to a processor for processing by the image recognition software. The image recognition software analyzes the image for the user and, once detected, processes the user image to identify those user personal characteristics that are used by the filter. When the pertinent user characteristics are identified, the filter uses them in conjunction with the filter database described above to provide recommendations of selections to the user. The processor of the filter and the processor that supports the image recognition processing may be the same device or different devices that have a data link.

The invention also provides a database and a method of creating a database that is associated with or accessed by a filter for making recommendations for a user of a media system or device that takes into account one or more user personal characteristics. The database includes selections and personal characteristics associated therewith. As noted above, the database may be organized according to selections (with associated personal characteristics) or according to personal characteristics (with associated selections).

The database may be compiled by a system comprising, for example, a processor and related software that is provided with input from a collection of users (referred to as a “user base”). Input from each user in the user base may comprise a selection of the user and one or more of his or her personal characteristics. The personal characteristics of users in the user base may be gathered automatically by an image capturing device trained on a user in the user base. The image may be transmitted to the system along with the selection, where it is analyzed using image recognition software to determine the personal characteristics of the user for the database. Alternatively, the image may be analyzed locally to the user for the personal characteristics and, once determined, the selection and the associated personal characteristics may be transmitted to the system for compilation in the database.

### BRIEF DESCRIPTION OF THE DRAWINGS

FIG. 1 is a representative view of a system that incorporates an embodiment of the invention;

FIG. 1a is schematic view of a component of FIG. 1 that support a filter of the present invention;

FIG. 2 are steps used by the system of FIG. 1;

FIG. 3 is a representative view of a system comprising a second embodiment of the invention; and

FIG. 4 are steps used by the system of FIG. 3.

### DETAILED DESCRIPTION

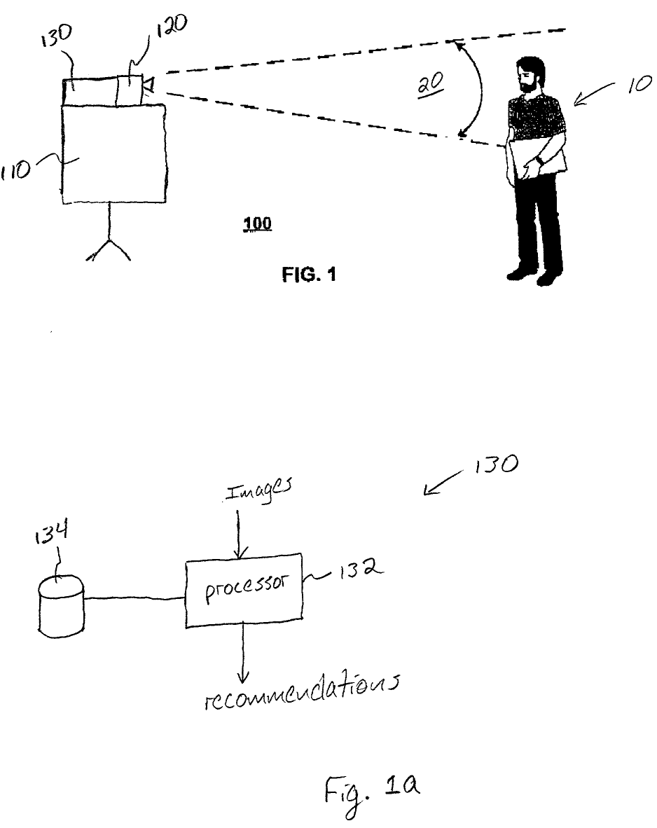

Referring to FIG. 1, a user 10 is shown positioned in the vicinity of a system 100 comprising an embodiment of the invention. The system 100 is comprised of a media system or device, such as a television 110. The system 100 is also comprised of a optical device, such as a digital camera 120, that has a viewing region 20 in which user 10 is positioned. The system 100 is also comprised of control unit 130

Control unit 130 interfaces with camera 120 and television 110. Control unit 130 supports the filter of the embodiment of the invention, described further below. Control unit 130 may incorporate functions apart from the filtering. For example, control unit 130 may incorporate the image processing of the digital images captured by camera 120, as well as some or all of the control functions of the television 110. Of course, some or all of the control and processing of components (such as camera 120 and television 110) ancillary to the filter of the present invention may take place in processors and/or control units apart from control unit 130. Such control and processing of components supportive of the present invention are well known in the art and, for convenience, their description will be omitted except to the extent necessary to describe the invention.

As noted, camera 120 captures images of a user 10 positioned in viewing region 20. Images from the camera 120 are sent to processor 132 of control unit 130, as shown in FIG. 1a. The images are typically comprised of pixel data, for example, those from a CCD array in a typical digital camera. The pixel data of the images is assumed to be pre-processed into a known digital format that may be further processed by processor 132. As noted above, such pre-processing of the images of digital camera 120 may take place in the processor 132 itself or in a separate processor, such as a processor in camera 120.

Processor 132 includes known image recognition software loaded therein that analyzes the image data received. If a user 10 is located in the viewing region 20, the image recognition software may be used to recognize the contours of a human body, such as the user 10. Alternatively, or once the user's body is located, the image recognition software may be used to recognize a face in the received image. The image recognition software further analyzes the user's face for one or more personal characteristics, such as gender, age and/or ethnicity.

If control unit 130 receives a series of images from camera 120, control unit 132 may detect and track a user that moves into the viewing region 20 of the camera 120 and, in particular may detect and track the approximate location of the user's head. Such a detection and tracking technique is described in more detail in “Tracking Faces” by McKenna and Gong, Proceedings of the Second International Conference on Automatic Face and Gesture Recognition, Killington, Vt., Oct. 14-16, 1996, pp. 271-276, the contents of which are hereby incorporated by reference. (Section 2 of the aforementioned paper describes tracking of multiple motions.)

Once a user 10 becomes stationary in the viewing region, for example, when the user 10 sits in a chair, the movement of the body (and the head) will be relatively stationary and the control unit 130 may initiate a separate or supplementary technique of face recognition that focuses on that portion of the subsequent images received from the camera 120. Further description of such face detection in a moving and/or static image is described in U.S. patent application Ser. No. 09/800,219 entitled “Automatic Positioning Of Display Depending Upon The Viewer's Location” for Srinivas Gutta, et al., filed Mar. 5, 2001, Attorney docket US010050, the contents of which are hereby incorporated herein by reference. In addition, detection of facial sub-classifications, such as gender and ethnicity using received images is described in “Mixture of Experts for Classification of Gender, Ethnic Origin and Pose of Human Faces” by Gutta, Huang, Jonathon and Wechsler, IEEE Transactions on Neural Networks, vol. 11, no. 4, pp. 948-960 (July 2000), the contents of which are hereby incorporated by reference and referred to below as the “Mixture of Experts” paper. The techniques in the Mixture of Experts paper may be readily adapted to identify other personal characteristics of a person in an image, such as age.

Once a pertinent personal characteristic of the user 10 is detected by the software of the processor 132 as described above, it is used to present recommendations to the user 10 based on the personal characteristic of the user 10. Thus, the processor 132 accesses filter database 134, which contains data records that correlate particular personal characteristics with available television programs. For example, if the particular personal characteristic of the user detected is gender and, in particular, male, the database is accessed for those select television programs that have “male” associated therewith. The select television programs are output as recommendations to the user 10, for example, via an on-screen display on the television 110.

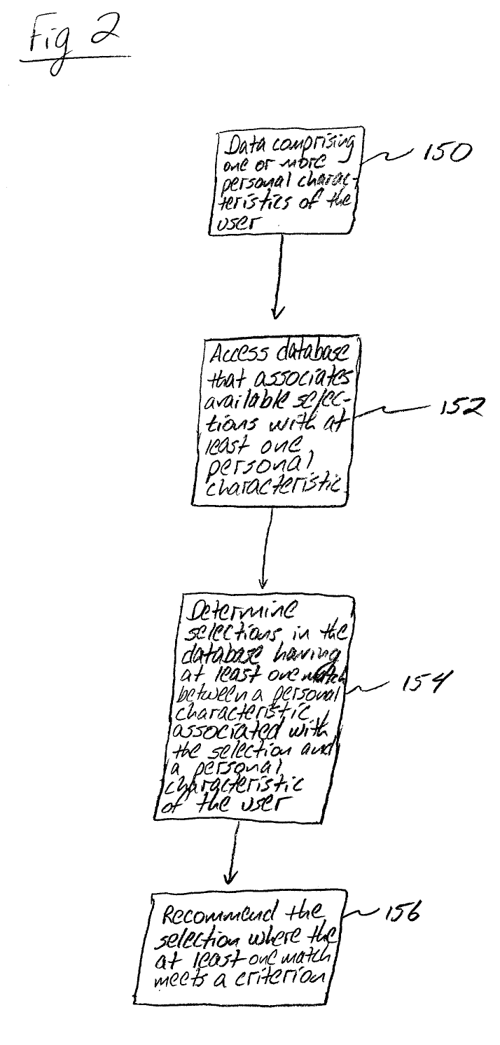

Turning momentarily to FIG. 2, a flowchart demonstrates principle steps of the embodiment for filtering selections available on a media system to present recommendations to a user. Thus, in step 150 data is received comprising one or more personal characteristics of the user. A database that associates available selections with at least one personal characteristic is accessed in step 152. A determination is made in step 154 of selections in the database that have at least one match between a personal characteristic associated with the selection and a personal characteristic of the user. Recommendation of a selection in the database is made in step 156 where the at least one match meets a criterion.

Referring back to FIGS. 1 and 1a, the recommendations, for example, may be limited to those programs that are currently available for viewing, or will be available during the next two hours. If there are more than one personal characteristic of the user 10 detected by the image recognition software, the recommendation may be made only if a program has associated personal characteristics that match all of the user's personal characteristics. Alternatively, for example, recommendations may be made in descending order, the order based on the number of matches between a program and the user's personal characteristics. Alternatively, each personal characteristic may be given a weighted value, based on its importance in making a recommendation. A score based on the weighted values is generated for those programs having at least one associated personal characteristics that match those of the user 10. The recommendations may be made in descending order based on the scoring. Alternatively (or in addition), the recommendations may be made only where the score of a program exceeds a threshold.

In addition, the user 10 may program the processor 132 so that the personal characteristics are processed in a particular manner (such as those described immediately above) to provide recommendations based on personal characteristics. The user 10 may also, for example, change the time interval for which programs are recommended. Such programming by the user 10 may be provided by an on-screen menu, for example.

In addition, the above-described exemplary embodiment provided recommendations to the user 10 based on the user's personal characteristic(s) alone. The processing may take into account other factors in addition to the user's personal characteristics. For example, database 134 may contain data records that correlate particular programs with other available television programs, as well as personal characteristics. The processor 132 may thus determine the user's personal characteristic(s) (as described above) and also note the particular program that the user 10 has selected when turning on the television 110. The database is accessed to determine the recommendation(s) for the user having the identified personal characteristics who selected the particular program.

For example, for a female watching sitcom A, the database 134 recommendations may include sitcom B, while for a male watching sitcom A, the database may recommend comedy program C. Thus, if the processor 132 identifies the user 10 as a male and further detects that the user has selected sitcom A after turning on the television 110, the processor 132, after accessing database 134, will recommend comedy program C to user 10.

Some or all of the processing of the processor 132 described for the above exemplary embodiment may occur elsewhere. For example, as noted, some or all of the image recognition processing may take place in the camera 120 or another processor and software associated with the camera 120. In that case, processor 132 would not receive images as shown in FIG. 1a, but would receive identified personal characteristics of the user 10 for processing related to recommendations, as described above.

In addition, database 134 may be part of the control unit 130, or may be a database in a remote location that is accessed by the control unit 130. Where the database is part of the control unit 130, the data associating available programs with personal characteristics may be downloaded, for example, from a server via a modem or the Internet. Where the database is located at a remote location (such as a server at an Internet location), the data may be accessed for recommendations via a modem or other communications interface. In the latter case, some or all of the recommendations processing may also take place at the remote server. Thus, processor 132 may provide the identified personal characteristic(s) of the user 10 to the remote server, where it is processed in a manner as described above, and a list of one or more recommendations is transferred from the remote server back to processor 132 for display to the user.

In addition, not only portions, but substantially all of the processing by control unit 130 described in the exemplary embodiment above, namely both the image recognition processing and processing relating to recommendations based on personal characteristics, may be located in a remote location, such as a server. Thus, for example, images captured via camera 120 may be transmitted via a modem or other communication link to a remote server, where the images are analyzed, one or more personal characteristics are identified based on the user's facial image, and recommendations of programs are made based on the personal characteristic(s) of the user 10. The recommendations are transferred from the remote server or site, where they are presented to the user 10 via display 110.

If there are multiple users in the viewing region 20 of FIG. 1, the system may detect and identify personal characteristics for some or all of the users. The system may identify the personal characteristics for only one user, the selection being based, for example, on the relative positions of the users in the viewing region 20. If personal characteristics for two or more users are identified, the filter may attempt to find a program (or programs) having associated personal characteristics that match the personal characteristics of all of the users. If no such program exists, the filter may find the program(s) having associated personal characteristics that most nearly match the personal characteristics of all of the users. The list of recommended selections may be ordered starting with the greatest number of matches. Again, the particular personal characteristics may be given a weighted value in matching selections with the users' personal characteristics.

As noted, the above-described particular exemplary embodiment is directed at providing recommendations of television programs to a user based upon the user's personal characteristics, wherein the personal characteristics are detected using image processing software. The invention may be applied to any media system or device that provides a selection to a user, including audio systems and the Internet. The media system need not be stationary, but can be, for example, located in an automobile or in a cell phone. For the Internet, the camera may operate in conjunction with a PC and provide recommendations of web-pages to users of the PC based upon personal characteristics of the user detected by a camera. As noted above, some or all of the processing pertaining to image recognition, determination of personal characteristics and determination of recommendations in such an embodiment may be located in a remote server.

In addition, the image recognition software described for the embodiment above was used to detect the user's face and then identify personal characteristics from his or her face. As an alternative, the image recognition software may be used to create a database of faces of particular users of the media system or device, as well as one or more associated personal characteristics of each stored face. Such associated personal characteristics may be detected by the image recognition software itself, or may otherwise be input by the user when the database is created. During operation (i.e., when recommendations are being made), the image recognition software may locate a face in the images received from the camera and then match the face in the images to a face of a particular user in the database. Once the match is made with a particular user, the associated personal characteristic(s) of the user may be used in providing recommendations, as described above. If there are multiple users of the system or device, in addition to the exemplary processing techniques described above, the system may also include a prioritization of known users and present recommendations to the recognized user having the highest priority.

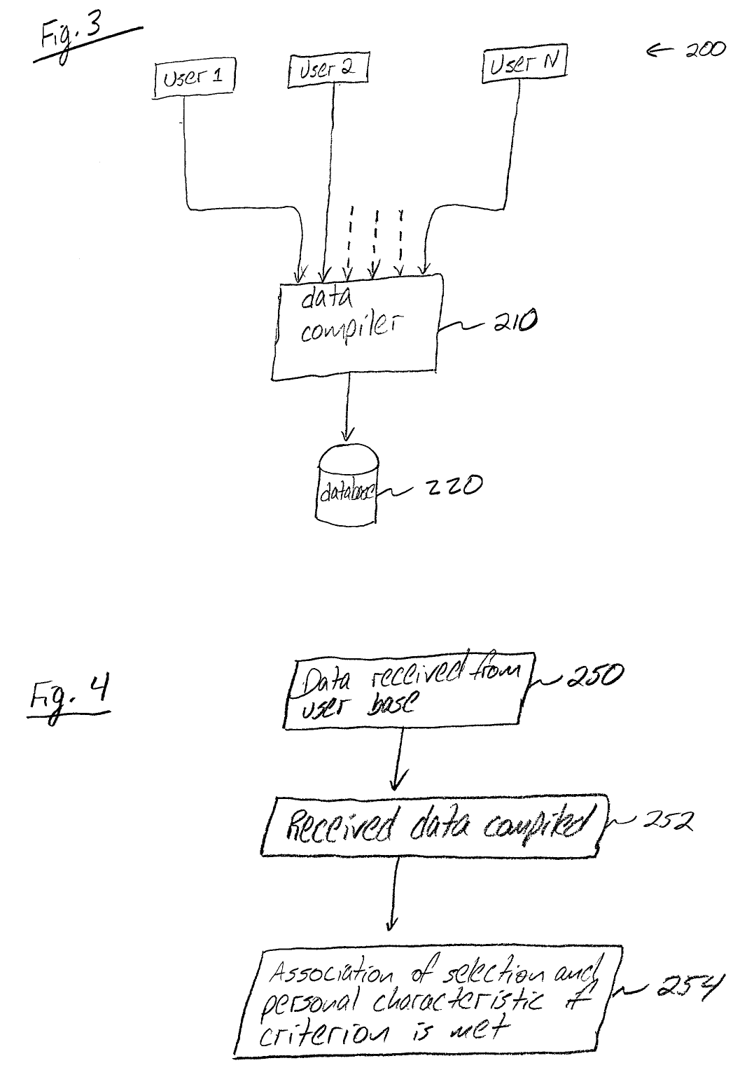

The invention also includes a recommendations database and a method of compiling a recommendations database that may be used, for example, with the above-described systems (such as database 134 of FIG. 1a) to make recommendations to a user using personal characteristics. FIG. 3 depicts an embodiment whereby such a recommendations database is created.

Referring to FIG. 3, a user base 200 used to create the recommendations database is comprised of N users, namely User 1, User 2, . . . , User N. Data is transferred from the users of the user base 200 to a data compiler 210. The transfer may be made in any manner, for example, by telephoning and questioning the users. In a preferred embodiment, data from users of the user base 200 is transferred via a communication link with the data compiler 210. Thus, data compiler 210 may be a remote server and the data may be transferred via a modem link with each user or over the Internet.

Data transferred from a user (User 1, User 2, . . . , User N) in the user base 200 comprises one or more personal characteristics of the user and one or more selections available on the pertinent media system or device for which the recommendations database 220 is being created. The data compiler 210 (which may comprise a processor, memory and application software) processes the received data and compiles it to make recommendations. For example, for the available selections, data compiler 210 may keep a count of the personal characteristics of those users who elect a selection. If a particular personal characteristic meets a criterion for a particular selection, for example, the number of users with the personal characteristic exceeds a threshold percentage, the personal characteristic is associated with the selection in the recommendations database 220.

Turning momentarily to FIG. 4, a flowchart depicts principle steps of the embodiment for creating a database for use in creating recommendations of selections available on a media system to a user. In step 250, data is received from a collection of users (a “user base”). The received data comprises at least one selection of each user and one or more personal characteristics of the user. The data received from the user base is compiled in step 252. In step 254, a selection and a personal characteristic in the database are associated in the database when a criterion is met.

Referring back to FIG. 3, in the exemplary case where the transferred data pertains to available television programs, then data transferred from the users in user base 200 will include one or more television programs that the user watches, along with one or more personal characteristics of the user. For example, the data transferred from User 1 may include the selection “Program A” and the personal characteristic (gender) “female”, the data transferred from User 2 may include “Program B” and the personal characteristic “male”, etc. Data compiler 210 may keep track of the number of males and females watching Program A, the number of males and females watching Program B, etc. If the number of males or females watching a program exceeds a threshold percentage, then the program is stored as a recommended selection for the gender in database 220.

Thus, for example, data compiler 210 may record that 88 users comprising 56 males (64%) and 32 females (36%) watch Program A. If the threshold percentage for a recommendation is 50%, then male is associated with Program A in the recommendations database 220. If the threshold is 35%, then both male and female is associated with Program A in the recommendations database 220.

Other selections are similarly processed and stored in the recommendations database 220. The received data from the users may be processed by data compiler 210 by compiling the received personal characteristic(s) of the users according to his or her selection, by compiling a chosen selection or selections of the users according to the pertinent personal characteristic, or some other organizational processing. Database 220 may be organized in like manners.

As noted, data may be transferred in any manner from the users comprising the user base 200 to the data compiler 220. For each user, data pertaining to the selection(s) and personal characteristic(s) may be collected in any of a number of ways. In particular, each user may have a media system or device for which the database is being created, along with a camera. The camera captures the image of the user, which is analyzed (either locally to the user or at the data compiler 210) by image processing software (analogous to that described above) to identify one or more personal characteristics of the user. The one or more personal characteristics of the user, along with the one or more selections of the user (which are also transmitted with the image or the identified personal characteristics to data compiler 210), are used by data compiler 210 in the manner described above to create the recommendations database 220. If there are more than one user of the media system or device (such as two viewers of a television program), the personal characteristics of all or part of the users may be used by the data compiler 210 in creating the database 220.

Once created, database 220 is used to make recommendations for a media system or device based on detected personal characteristics, as described above. The database may be downloaded to individual media systems, or it may be accessed at a centralized location, as also described above. Data compiler may also include other associations in addition to personal characteristics in creating the recommendations database. For example, data received from users in the user base 200 may include an initial selection and one or more subsequent selections of a user, as well as the user's personal characteristics. For each such initial selection (such as Program A) by users in the user base 200, the data compiler 210 may keep track of the user's personal characteristics (such as gender) and subsequent selection (such as Program B). If the number of users having a particular personal characteristic (such as number of male users) that select a subsequent program (such as Program B) meets a criterion (for example, a threshold percentage), then the subsequent program (Program B) is associated in the recommendations database for males who view the initial program (Program A). Data for other selections (such as Program B) are compiled when they are chosen by users in the user base 200 as an initial selection.

The following four documents are hereby incorporated by reference herein:

1) “Pfinder: Real-Time Tracking Of the Human Body” by Wren et al., M.I.T. Media Laboratory Perceptual Computing Section Technical Report No. 353, published in IEEE Transactions on Pattern Analysis and Machine Intelligence, vol. 19, no. 7, pp 780-85(July 1997), which describes a “person finder” that finds and follows people's bodies (or head or hands, for example) in a video image

2) “Pedestrian Detection From A Moving Vehicle” by D. M. Gavrila (Image Understanding Systems, Daimler Chrysler Research), Proceedings of the European Conference on Computer Vision, Dublin, Ireland (2000) (available at www.gavrila.net), which describes detection of a person (a pedestrian) within an image using a template matching approach.

3) “Condensation—Conditional Density Propagation For Visual Tracking” by Isard and Blake (Oxford Univ. Dept. of Engineering Science), Int. J. Computer Vision, vol. 29, no. 1, pp. 5-28 (1998) (available at www.dai.ed.ac.uk/CVonline/LOCAL_COPIES/ISARD1/condensation.html, along with the “Condensation” source code), which describes use of a statistical sampling algorithm for detection of a static object in an image and a stochastical model for detection of object motion.

4) U.S. patent application Ser. No. 09/685,683 entitled “Device Control Via Image-Based Recognition” of Miroslav Trajkovic, Yong Yan, Antonio Colmenarez and Srinivas Gutta, filed Oct. 10, 2000, Attorney docket US000269.

In addition, it is noted that software that can recognize faces in images (including digital images) is commercially available, such as the “FaceIt” software sold by Visionics and described at www.faceit.com.

Although illustrative embodiments of the present invention have been described herein with reference to the accompanying drawings, it is to be understood that the invention is not limited to those precise embodiments, but rather it is intended that the scope of the invention is as defined by the scope of the appended claims.

What is claimed is:

1. A filter associated with a media system, the filter receiving data comprising one or more personal characteristics of a user of the media system, the filter determining at least one recommendation for the user of a selection available on the media system based upon at least one of the personal characteristics of the user.

2. The filter as in claim 1, wherein the data comprising one or more personal characteristics of the user received by the filter comprises an image that includes the user, the image being processed by the filter to identify the one or more personal characteristics of the user.

3. The filter as in claim 2, wherein the filter uses image recognition software to process the image.

4. The filter as in claim 1, wherein the data comprising one or more personal characteristics of the user received by the filter comprises an indicium of one or more personal characteristics of the user.

5. The filter as in claim 1, wherein the one or more personal characteristics of the user is at least one of gender, age and ethnicity.

6. The filter as in claim 1, wherein the filter accesses a recommendations database to determine the at least one recommendation for the user.

7. The filter as in claim 6, wherein the recommendations database is located at a remote server.

8. The filter as in claim 6, wherein the recommendations database is part of the filter.

9. The filter as in claim 6, wherein the database includes a number of records comprising an available selection and at least one associated personal characteristic.

10. The filter as in claim 9, wherein the database is accessed to determine those selections having one or more associated personal characteristics that match one or more personal characteristics of the user.

11. The filter as in claim 10, wherein the at least one recommendation for the user of a selection is made when the one or more personal characteristics associated with the selection that match one or more personal characteristics of the user meets a criterion.

12. A database that is accessed by a filter to provide a recommendation of one or more selections available on a media system to a user, the database having a number of records comprising an available selection and at least one associated personal characteristic.

13. The database as in claim 12, wherein the records comprise an available selection, at least one associated personal characteristic and at least one associated selection available on the media system.

14. The database as in claim 12, wherein the at least one associated personal characteristic is one of gender, age and ethnicity.

15. A method of filtering selections available on a media system to present recommendations to a user comprising the steps of:
a) receiving data comprising one or more personal characteristics of the user;
b) accessing a database that associates available selections with at least one personal characteristic;
c) determining selections in the database that have at least one match between a personal characteristic associated with the selection and a personal characteristic of the user;
d) providing a recommendation of a selection in the database where the at least one match meets a criterion.

16. The method as in claim 15, wherein the criterion is a threshold number.

17. The method as in claim 15, wherein the step of receiving data comprising one or more personal characteristics of the user includes receiving image data of the user and processing the image data to determine the one or more personal characteristics of the user.

18. A method of creating a database for use in creating recommendations of selections available on a media system to a user comprising the steps of:
a) receiving data from a collection of users (a “user base”), the data comprising at least one selection of each user and one or more personal characteristics of the user;
b) compiling the data received from the user base; and
c) associating a selection and a personal characteristic in the database when a criterion is met.

19. The method as in claim 18, wherein compiling data from the user base comprises determining users having a same selection and, for the selection, determining totals of the number of users having the same personal characteristic.

20. The method as in claim 19, wherein the step of associating a selection and a personal characteristic in the database when a criterion is met comprises determining whether the number of users with the same personal characteristic exceeds a threshold.

21. The method as in claim 18, wherein compiling data from the user base comprises determining users having a same personal characteristic and, for the personal characteristic, determining totals of the numbers of users having the same selection.

22. The method as in claim 21, wherein the step of associating a selection and a personal characteristic in the database when a criterion is met comprises determining whether the number of users having the same selection exceeds a threshold.
